(19) United States
(12) Patent Application Publication
(10) Pub. No.: US 2025/0174999 A1
(43) Pub. Date: May 29, 2025

(54) System and Method for an Electric Vehicle Powered Microgrid

(71) Applicant: Vincent Loccisano, Wellesley, MA (US)

(72) Inventor: Vincent Loccisano, Wellesley, MA (US)

(21) Appl. No.: 19/040,162

(22) Filed: Jan. 29, 2025

(51) Int. Cl. H02J 3/32; B60L 55/00; H02J 3/00; H02J 3/38

(52) U.S. Cl. CPC H02J 3/322; B60L 55/00; H02J 3/001; H02J 3/388

(57) ABSTRACT

A system and method is a microgrid designed to access unused electricity from EVs and to convert, store, and make available electricity for use during emergencies. The system may comprise EVs, energy storage, converters, and electronics switches to regulate the voltage and frequency fluctuations, smart controls, and a set of consumers. The system is a reliable fallback for providing power to critical facilities and devices when utility grids are thrown offline in the event of natural or manmade disasters. In some embodiments the system is an islanded microgrid, in other embodiments, the system interfaces with a utility grid.

### FIELD OF THE INVENTION

The present invention relates to a system and method for using electric vehicles (EVs) as power sources for a microgrid during emergencies or natural disasters. Specifically, it involves the use of EVs to supply power as either direct current (DC) or alternating current (AC) to a microgrid that operates independently of the utility electrical grid.

### BACKGROUND OF THE INVENTION

During natural disasters or emergencies, conventional power infrastructure may become compromised, leading to power outages and disruptions. Traditional centralized power grids often suffer from vulnerabilities to large-scale outages due to natural disasters, cyberattacks or equipment failures. Increased integration of distributed generation resources such as solar and wind energy presents complexities in grid management and stability.

A microgrid is a localized, small-scale electricity network that can operate independently or in conjunction with a main power grid. Microgrids offer provide backup power during grid outages and enable integration of distributed energy resources. Localized transmission results in reduced transmission losses.

Large enterprises like hospitals often have microgrids that serve as backup power in the event of a power outage. These microgrid systems may use fossil-fuel energy, solar, wind, or other energy sources, and may store their energy in batteries. Microgrids have interconnected loads and distributed energy resources in a controllable system.

Some microgrids are completely separate from the utility grid. These “islanded” microgrids stand on their own, independent of the utility grid, and can be relied upon for electricity during a widespread power outage. Utility-scale electrical grids are vulnerable to increasing natural and man-made disasters, and recent natural disasters-hurricanes, wildfires, and extreme weather events-have caused widespread power outages that have lasted for weeks. These disruptions can have serious consequences, affecting essential services like healthcare, communication and transportation. The increasing frequency and intensity of these events show a need for improved resilience in the nation's power grid.

An islanded microgrid could be used as a backup energy source that is completely separate from the utility grid, providing a reliable alternative in the event of a natural or man-made disaster that might cripple the utility grid. This type of grid could be powered by electric vehicles (EVs), which come equipped with substantial battery capacities. EVs have the capacity to power a microgrid for a significant period of time without relying on the main utility grid.

When an EV is charged using a standard charger, AC power from the grid is rectified to DC power by an onboard rectifier that is part of the charging system within the EV. AC current from the grid is rectified to DC current before being stored in the battery as DC power. DC “fast chargers” speed the charging process by rectifying AC power from the grid to DC power in the charging station, to deliver DC power directly to the EV battery, bypassing the vehicle's onboard rectifier. Wireless power transfer (WPT) is a technology that enables electric vehicles to charge without wires, cords or plugs. WPT uses magnetic induction to transfer power between a transmitter, which is commonly a flat object installed on a flat surface, and a receiver, which is commonly built into the underside of the EV.

Most EVs are powered by AC motors with permanent-magnet synchronous motors (PMSM). An inverter in the EV inverts the stored DC power to AC power to drive the PMSM motor. The power inverter transforms DC power from batteries into AC power to run the PMSM, or may alternatively be used to power home appliances and devices.

An islanded microgrid could be part of a system that pulls power from multiple electric vehicles, storing the energy to be used in the event of a power outage.

A bi-directional rectifier/inverter (also referred to as a rectifier/inverter or inverter/rectifier), is a device that handles power flow from DC to AC and back, from AC to DC. A rectifier/inverter is used in an uninterruptible power supply that uses a rectifier to charge a battery from AC power and an inverter to provide AC power to connected devices during a power outage.

### SUMMARY OF THE INVENTION

A system and method is an islanded microgrid designed to access electricity from one or more electric vehicles to supply their available power to a microgrid in the event of a grid failure. In an example embodiment EVs supply power as DC current to a DC microgrid, which may store the energy in DC batteries and rectify the energy to AC current for use by individuals or facilities. In another example embodiment, EVs deliver AC current, via the EV onboard inverter, to an AC microgrid that delivers the AC current to individuals or facilities without the need to invert the current before it is delivered. One skilled in the art understands that an AC microgrid may deliver power directly to an end user as AC current, or may store some of the energy in batteries wherein the AC current would be inverted to DC current for storage. Alternative generation sources include wind, solar or generators may also provide power to a microgrid. Electric vehicles

One skilled in the art understands that supplying power as DC current to a DC microgrid offers relatively faster delivery of energy to the microgrid. The DC current may be used for fast charging of other DC batteries, or may be rectified to AC current before delivery to end users. Supplying power as AC current through an EV onboard rectifier provides a relatively slower delivery of power to the grid with relatively faster, seamless delivery to end users. In both cases, electric vehicles may be used to supply energy to the microgrid and may also be used as energy storage by charging EV batteries for later use by the microgrid.

In an example embodiment, a network of EVs are deployed as part of a disaster relief action. The EVs located in or near a medical center's parking structure are connected to a microgrid that provides electricity to the medical center. The system is a reliable fallback for providing power to critical facilities and devices when utility grids are thrown offline during natural or manmade disasters. In this example the microgrid may be in communication with the existing utility grid wherein EVs may be charged while the utility grid is operational and subsequently used as a power source when the utility grid is not operational. The microgrid may interface with an existing electrical grid, or may operate when the electrical grid is no longer operational, when the electrical grid is no longer grid connected, or when the electrical grid is connected but subject to outages. The microgrid may be readily reconfigurable for power output to meet local requirements such as providing 220 volts at 50 hz as needed or providing 120 volts at 60 hz as needed.

In another embodiment the microgrid system is a self contained unit assembled in a container configured to meet the standards of a common shipping container. The microgrid system in a shipping container may be rapidly deployed to disaster areas as part of disaster relief actions.

### BRIEF DESCRIPTION OF DRAWINGS

FIG. 1 is a perspective view of an example embodiment.

FIG. 2 is a perspective view of an iteration of the embodiment.

FIG. 3 is a flowchart of the method of the embodiment.

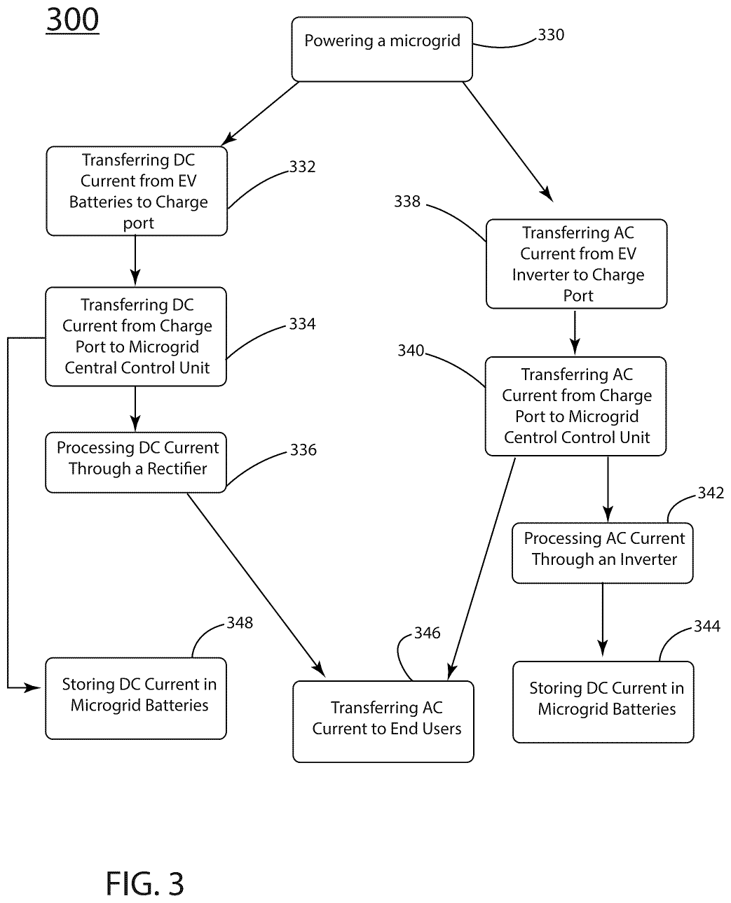

### DETAILED DESCRIPTION OF THE INVENTION

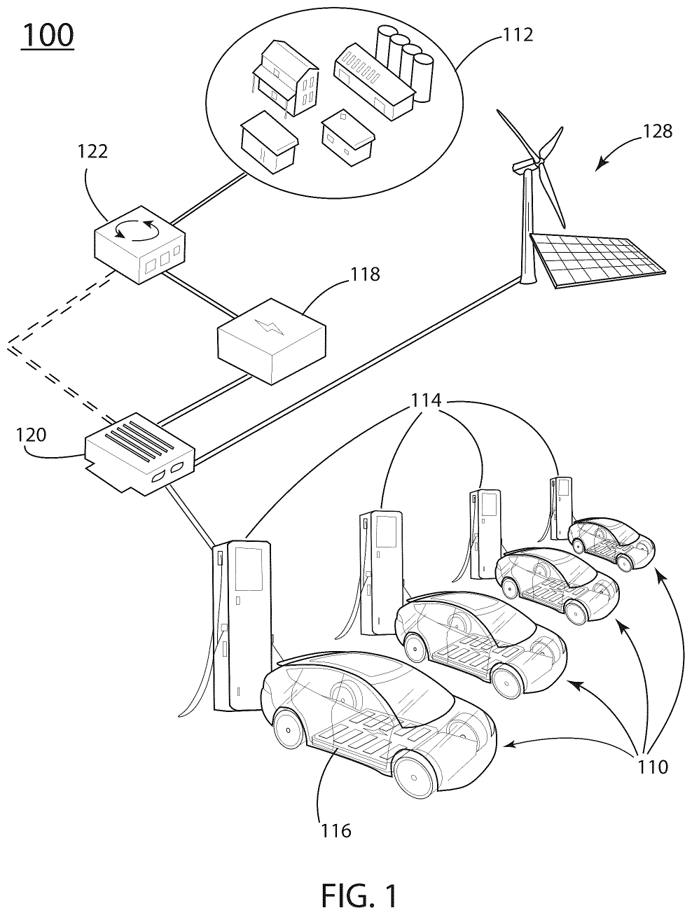

In FIG. 1, 100, EVs 110 are connected to a microgrid via designated charging ports 114. A microgrid system that operates on direct current (DC) receives DC current from EVs. In this example, the DC current is transferred through the charging ports 114 and then to a microgrid central control unit 120. The microgrid central control unit 120 manages the distribution of power within the microgrid. Electrical energy stored as DC power in the EV batteries may be transferred to batteries 118 in the microgrid without conversion to AC power. This enables rapid transfer of power from DC batteries in the EVs to DC batteries in the microgrid. A rectifier 122 rectifies DC current to AC current before it is sent as AC power to end users 112. Depending on the immediate need, the central control unit 120 may alternatively receive the DC current and send it directly to an inverter/rectifier 122 before transfer for end use 112. One skilled in the art understands that the energy stored in the batteries 118 may later be used to charge vehicles 110 through direct transfer to vehicle batteries 116 as a DC-to-DC fast-charge. This can occur post-emergency in which the microgrid has provided power to end users 112.

In some embodiments, alternative energy sources such as wind and solar 128 may also contribute to the microgrid as current from alternative energy sources 128 is directed to the central control unit 120 where it may be distributed to end users or stored. In an example use of the embodiment, current may be directed through the central control unit to be stored in the electric vehicle batteries 116. In this manner, electric vehicles may be used as both a source of power, and a means for power storage.

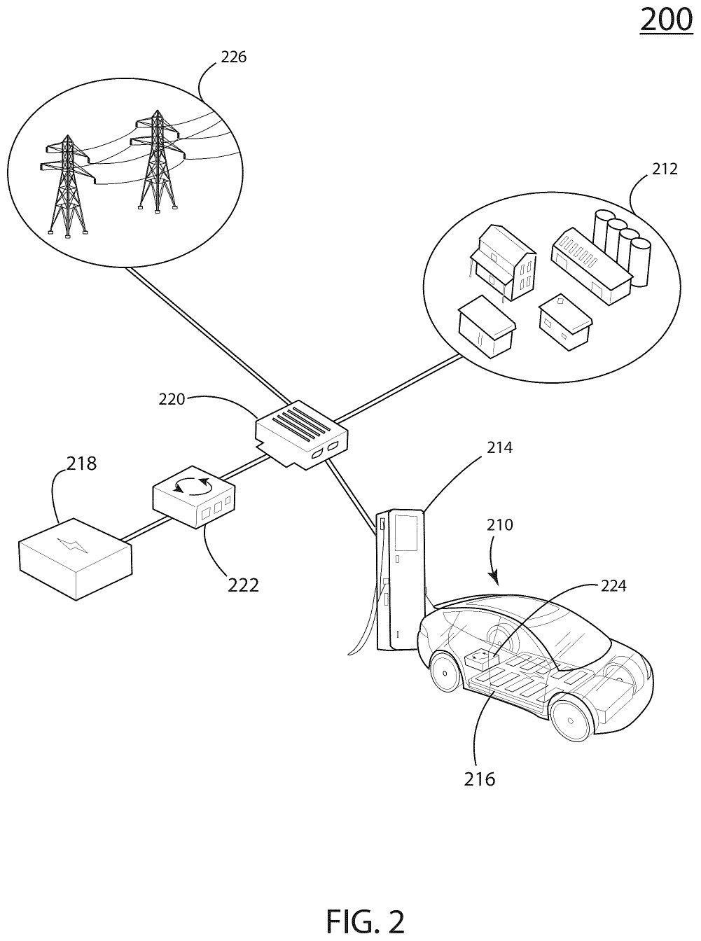

FIG. 2 shows an iteration 200 of an AC microgrid. An onboard power rectifier 224 in an example EV 210 rectifies DC power from EV batteries 216 to AC power that is transferred through a charge port to the microgrid central control unit 220. The AC current may be directed by the microgrid central control unit 220 directly to end users 212 or may alternatively be directed through a microgrid inverter/rectifier 222 to be stored in microgrid batteries 218.

In another embodiment the microgrid central control unit 220 is configured to interface with an electrical grid 226 to provide power when the grid is no longer grid-connected or when the grid is grid-connected but subject to outages.

In an example use of the embodiment, current may be directed through the onboard rectifier 224 in the electric vehicle 210 to be stored in the electric vehicle batteries 216. In this manner, electric vehicles may be used as a source of power and a means for power storage.

One skilled in the art understands that energy stored in the microgrid batteries 218 may later be rectified through the microgrid rectifier/inverter 222 to be controlled by the microgrid central control unit 220 for use by end users 212.

Each microgrid operates independently of the main utility electrical grid, obviating any need for synchronization and complex load management. This ensures rapid deployment and reliable power supply during emergencies.

1. A microgrid system comprising:
providing at least one electric vehicle having an electric vehicle battery, electrically coupled with a charge port; and
the charge port electrically coupled with a microgrid central control unit; and
the microgrid central control unit electrically coupled with at least one microgrid battery and further electrically coupled with a rectifier/inverter; wherein
DC current from the electric vehicle battery may be transferred through said charge port, controlled by the microgrid central control unit and transferred to the microgrid battery wherein it may be rectified in the rectifier/inverter before provided to at least one end user.

2. The microgrid system of claim 1 wherein:
the system is deployed as part of a disaster relief action.

3. The microgrid system of claim 1 further comprising:
alternative generation sources connected with, and supplying power to, the microgrid.

4. The microgrid system of claim 1 wherein;
current provided to at least one end user is converted to meet local voltage and hertz requirements.

5. The microgrid system of claim 1 further comprising:
a container configured for housing the microgrid system components wherein;
the microgrid system may be shipped for rapid deployment.

6. The microgrid system of claim 1 wherein:
the microgrid is configured for interfacing with an existing electrical grid.

7. The microgrid system of claim 5 wherein:
the existing electrical grid is not grid connected.

8. The microgrid system of claim 5 wherein:
the existing electrical grid is grid connected but subject to outages.

9. The microgrid system of claim 1 further comprising:
each charge port provides bidirectional power delivery wherein:
each electric vehicle having an electric vehicle battery is a power source component of the microgrid and a battery storage component of the microgrid.

10. The microgrid system of claim 9 wherein:
the microgrid is in communication with an existing utility grid wherein;
each electric vehicle having an electric vehicle battery is charged while the utility grid is operational and is used as a power source when the utility grid is not operational.

11. A microgrid system comprising:
providing at least one electric vehicle having an electric vehicle battery and an on-board inverter/rectifier, electrically coupled with a charge port; and
the charge port electrically coupled with a microgrid central control unit; and
the microgrid central control unit electrically coupled with an end user electric power circuit; and further electrically coupled with at least one microgrid inverter/rectifier that is in turn electrically coupled with a microgrid battery; wherein
AC current from the electric vehicle battery inverted by said on-board inverter/rectifier transferred through said charge port, is controlled by the microgrid central control unit and transferred to the end user electric power circuit and further managed by the microgrid central control unit through the microgrid inverter/rectifier to invert the AC current to DC current that is in turn stored in the microgrid battery.

12. The microgrid system of claim 11 further comprising:
the microgrid is in communication with an existing utility grid wherein;
each electric vehicle having an electric vehicle battery is charged while the utility grid is operational and is used as a power source when the utility grid is not operational.

13. The microgrid system of claim 11 further comprising:
each charge port provides bidirectional power delivery wherein:
each electric vehicle having an electric vehicle battery is a power source component of the microgrid and a battery storage component of the microgrid.

14. A method of using the apparatus of claim 1, the method comprising:
powering a microgrid; by
transferring DC current from at least one EV battery to a charge port; and
transferring DC current to a microgrid central control unit; and
processing DC current through a rectifier to produce AC current; and
transferring AC current to end users.

15. The method of claim 14 further comprising:
transferring DC current from a microgrid central control unit to a microgrid battery.

16. A method for using the apparatus of claim 14, the method comprising:
powering a microgrid; by
transferring AC current from at least one EV battery, through an EV on-board inverter, to a charge port; and
transferring AC current from to a microgrid central control unit; and
transferring AC current from said microgrid central control unit to end users.

17. The method of claim 16 further comprising:
processing AC current through an inverter to produce DC current; and
storing DC current in at least one microgrid battery.
